(19) United States
(12) Patent Application Publication
(10) Pub. No.: US 2005/0144128 A1
(43) Pub. Date: Jun. 30, 2005

(54) Mechanism and process for processing financial transactions

(76) Inventors: Phillip Ace McCoppin, Wood Ridge, NJ (US); Richard C. Boyle, Rahway, NJ (US)

Correspondence Address: PILLSBURY WINTHROP SHAW PITTMAN, LLP, P.O. BOX 10500, MCLEAN, VA, 22102, US

(21) Appl. No.: 10/747,612

(22) Filed: Dec. 30, 2003

(51) Int. Cl. G06F 17/60

(52) U.S. Cl. 705/40; 705/39

(57) ABSTRACT

A mechanism and process for authorization and processing payouts to transaction beneficiaries in foreign countries. The mechanism and process provide for initiation of self-funded transactions, the initial instruction therefore being in a format associated with a mechanism that provides guaranteed funding of the transaction to a Receiver Financial Institution, for example, Fedwire. The Receiver Financial Institution generates foreign financial transaction payment instructions including data in a format that is compatible with both the Receiver Financial Institution and at least one financial institution in a foreign country, for example, by using a SWIFT compatible format.

### BACKGROUND OF THE INVENTION

1. Field of the Invention

The present invention relates to a mechanism and process for processing financial transactions, particularly to a mechanism and process for processing payouts to transaction beneficiaries in foreign countries.

2. Description of Related Art

Many financial institutions use the Society for Worldwide Interbank Financial Telecommunication (SWIFT), which is an industry-owned cooperative supplying standardized messaging services and interface software, to initiate international payments, while using the U.S. Federal Reserve's Fedwire Funds Service to initiate domestic funds transfers.

As illustrated in FIG. 1, international payouts such as wires often require an originating financial institution 110 to identify one or more intermediary banks 120 necessary to handle the transaction in a Fedwire-format transaction message; additionally, the originating bank must identify a foreign beneficiary bank 130 associated with a foreign beneficiary 140, which is responsible for making final payment to that beneficiary in that Fedwire-format transaction message. Personnel at the originating bank 110 must research which banks are required to fulfill the funds transfer payment. Bank personnel most often rely on dated paper documents to determine the intermediary banks 120 and those banks' associated interbank identifier designations. To take advantage of a fully automated funds movement mechanism, the correct designation of the Foreign Beneficiary Bank 130 must also be known. Thus, such an approach often suffers from the disadvantages of having to maintain correspondent bank information, incorrect selection of intermediary banks, and frequent returned wires.

Alternatively, as illustrated in FIG. 2, some originating financial institution 210 use third party service 220, which can automate the research process for determining Foreign Beneficiary Banks 230 and any related intermediary banks and provide pre-submission editing of instruction fields. However, these proprietary services generally use their own proprietary payment order formats or SWIFT coding and formats and can require manual steps to check originator balances, or post the funding to an originating financial institution's account system. Additionally, compliance requirements such as those required by Office of Foreign Assets Control (OFAC) screening are not universally integrated into such third party services. In the case of large scale proprietary systems, the applicability of compliance process is not clear.

Thus, such conventional processes for initiating international payments require originating banks to perform time and labor intensive manual, error-prone tasks or retain a third party proprietary service; additionally, the degree of automation provided by such third party services varies. Specifically, because these proprietary systems are not interfaced to a guaranteed-funded, originating financial institution's domestic Fedwire payment system, additional manual steps may be required to check the originating financial institution's balance for funds availability, post the transaction to their Demand Deposit Account (DDA) system and make the required general ledger entries. Compliance checking for OFAC blocked entities may also be performed manually. Such extra manual steps are prone to costly errors, potential compliance violations and expenses associated with SWIFT membership. Such systems do not provide a cohesive structure for audit and investigations.

### SUMMARY OF THE INVENTION

In accordance with at least one embodiment of the invention, a mechanism and process for facilitating processing payouts to transaction beneficiaries in foreign countries initiate self-funded transactions that are formatted in accordance with Fedwire requirements and include data that is SWIFT compatible.

In accordance with at least one embodiment of the invention a mechanism and process enables domestic (i.e., United States) banks to issue payments through a Receiver Financial Institution to foreign (i.e., non-United States) beneficiaries using the domestic bank's existing interfaces to the Fedwire system, which allows such a domestic bank to utilize their present processing capacity without having to: (i) build additional interfaces to a proprietary bank system; (ii) become a member of the SWIFT network; or (iii) maintain balances at an initial intermediary bank or provider of a proprietary funds transfer service.

### BRIEF DESCRIPTION OF THE DRAWINGS

A more complete appreciation of the invention and much of the utility thereof will become readily apparent with reference to the following detailed description of several embodiments of the invention, particularly when considered in conjunction with the accompanying drawings, in which:

FIG. 1 illustrates an example of a conventional approach to processing payouts to transaction beneficiaries in foreign countries;

FIG. 2 illustrates another example of a conventional approach to processing payouts to transaction beneficiaries in foreign countries;

FIG. 3 illustrates an example of a mechanism for performing financial transactions in accordance with at least one embodiment of the invention; and

FIG. 4 illustrates an example of a transaction processing flow in accordance with at least one embodiment of the invention.

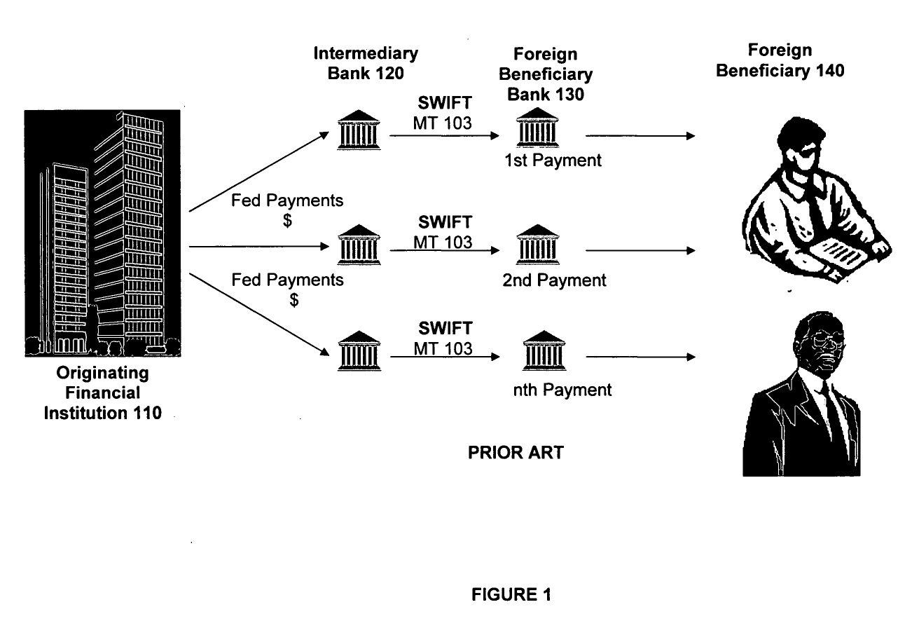

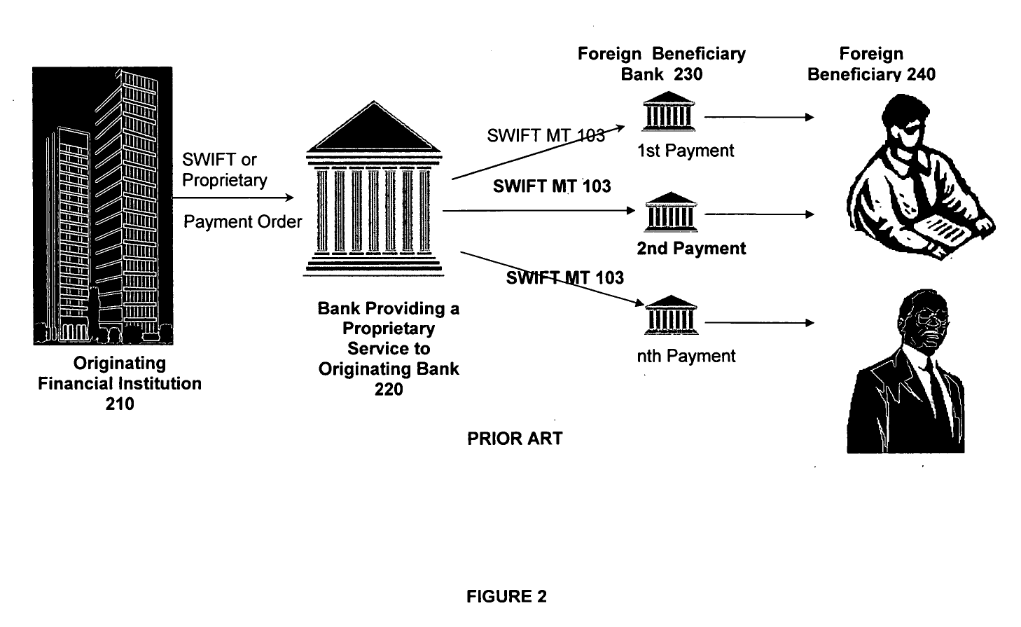

### DETAILED DESCRIPTION OF SEVERAL EMBODIMENTS

It should be understood that at least part of the utility of this invention is based on an assignment of role implied by the various titles used to describe various involved financial institutions and a particular convention and workflow that facilitates a self-funded and compliant payout instruction.

In accordance with at least one embodiment of the invention, a payment authorization and delivery mechanism is provided for providing payouts to beneficiaries in foreign countries through either (i) a Receiver Financial Institution branch, (ii) through a member of the ClearingHouse Interbank Payment System (CHIPS) or the U.S. Fedwire funds transfer system; or (iii) a SWIFT connected correspondent to the Receiver Financial Institution that handles business in a particular country. This includes an authorization through the U.S. Federal Reserve Bank Fedwire system using particularly encoded messages, including a special U.S. dollar account for currency conversion, and an adherence to messaging standards complying with specifications of SWIFT's funds transfer instructions (“MT 103”).

An instruction for a payment from a domestic, i.e., United States, originating bank, known initially as the Originator's Financial Institution (and referred to hereafter as a “Client Bank”, being a client of the organization providing the processing mechanism) to the Receiver Financial Institution includes identification of the beneficiary or payee and the financial institution where payment is to be delivered (understood conventionally to be the Foreign Beneficiary Bank and referred to hereafter also as the “Paying Bank”). A Receiver Financial Institution is a financial institution associated with the mechanism and/or process of the invention, e.g., operating and/or maintaining the mechanism and/or process to provide a financial transaction processing service to a plurality of Client Banks.

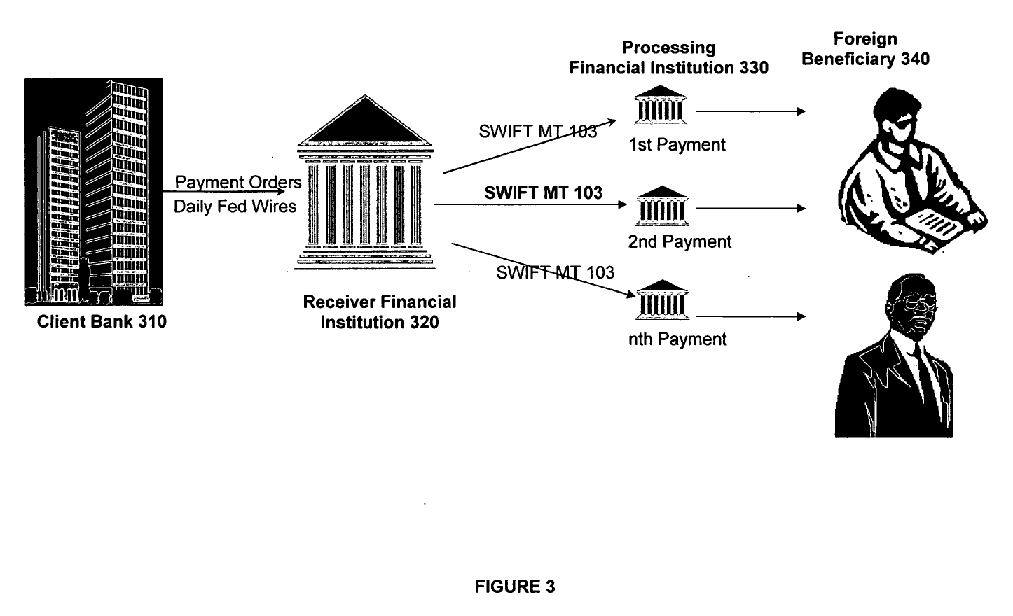

FIG. 3 illustrates an example of a mechanism for performing financial transactions in accordance with at least one embodiment of the invention. As illustrated in FIG. 3, instructions associated with international payouts such as wires are transmitted from the Client Bank 310 to the Receiver Financial Institution 320 (which both are participants in the Fedwire system). Financial transaction instructions associated with a financial transaction benefiting a foreign beneficiary are transmitted from the Client Bank 310 to the Receiver Financial Institution 320. These financial transaction instructions are transmitted to the Receiver Financial Institution 320 using the Client Bank's 310 existing Fedwire interface and, thus, allow the Client Bank 310 to maintain its existing automated interfaces to its general ledger, funds control and, most importantly, its various compliance screening systems eliminating the need to re-key or build instruction migration processes. Moreover, utilizing the Receiver Financial Institution's mechanism for processing such transactions allows the Client Bank 310 to keep international financial transactions in the same Fedwire based processing flow as their domestic financial transactions.

Thus, the Receiver Financial Institution 320 obtains all necessary information for processing the international financial transaction through a single authorizing instruction delivered through the U.S. Federal Reserve Bank's Fedwire process; moreover, the mechanism executes the international financial transaction in an environment that is no different than that used for domestic wire transfers. Formatting requirements for the authorizing instruction (explained with reference herein to Table 1) are compatible with the guidelines for processing domestic transactions for Fedwire; in other words, the Client Bank 310 may generate international financial transaction instructions using the Fedwire format and transmit them via the Fedwire system. Therefore, domestic and international payments can be mixed into the same stream of instructions to Fedwire.

Once the financial transaction instructions are received by the Receiver Financial Institution 320, the financial transaction processing mechanism, implemented via one or more computer processors resident in one or more computers maintained by the Receiver Financial Institution 320, is used to analyze the instructions to identify specific information including information associated with the instructing financial transaction. Specifically, the Receiver Financial Institution's financial transaction processing mechanism identifies necessary intermediary and processing financial institutions, relieving bank personnel from research and manual input of necessary destination codes. The mechanism and process provide auto-intermediary payment processing, which selects a Processing Financial Institution 330 (for the country of beneficiary payment) based on a foreign beneficiary bank CHIPS Universal IDentifier (UID) or SWIFT Bank Identifier Code (BIC). This automated selection eliminates or avoids possible errors when a bank resorts to dated reference material including international banking directories and manual files. Moreover, because the financial transaction processing mechanism is a single process administered by the Receiver Financial Institution 320, tracing and error inquiries deal with a single integrated system rather than a collection of processes, which may use differing formats, varying control mechanisms, and often require some amount of manual activity.

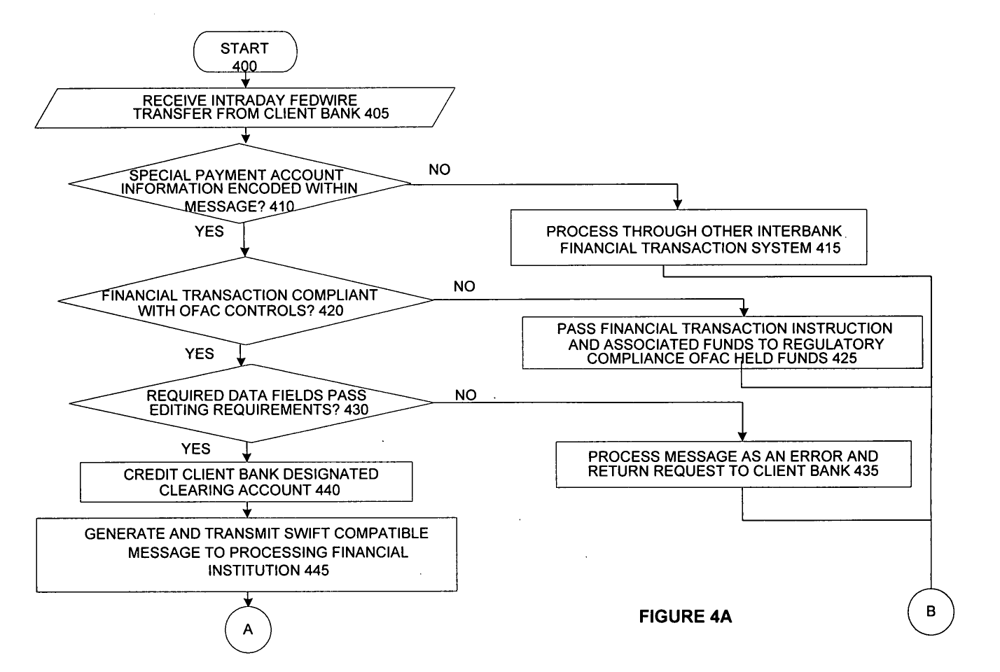

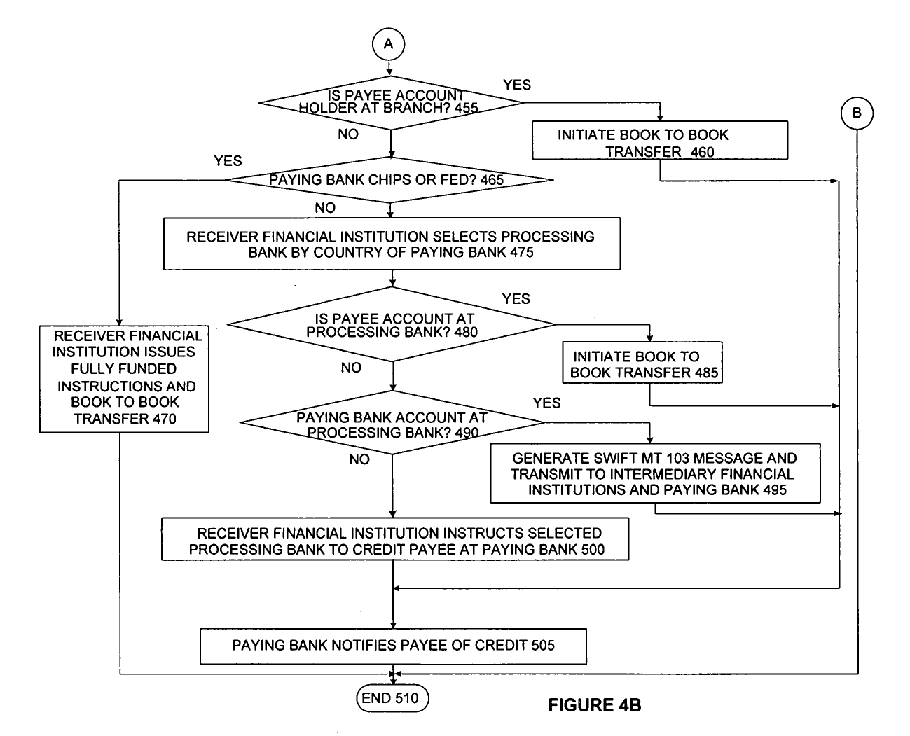

Within the generated SWIFT compatible message, the customer of the Client Bank 310 ordering the payment, i.e., the individual originator of the financial payout transaction, is specified along with his financial institution (i.e., the Client Bank 310), and the Processing Financial Institution 330, e.g., a branch of the Receiver Financial Institution, a correspondent of the Receiver Financial Institution or a SWIFT capable financial institution that is a part of an international funds transfer settlement consortium (as explained with reference to FIG. 4 herein).

This SWIFT compatible message is then transmitted to a foreign Processing Financial Institution 340 (which may be a branch of the Receiver Financial Institution, a correspondent of the Receiver Financial Institution or a SWIFT capable financial institution that is a part of an international funds transfer settlement consortium, as explained with reference to FIG. 4 herein) for subsequent direct or indirect credit to the foreign beneficiary/payee 340.

FIG. 4 illustrates a method of processing payouts to transaction beneficiaries in foreign countries in accordance with at least one embodiment of the invention. As illustrated in FIG. 4, the process begins at 400 and proceeds to 405, at which a Fedwire intraday transfer is received from a Client Bank via the Receiver Financial Institution's Fedwire system interface in the Fedwire prescribed message format.

Table 1 includes an illustration of the Fedwire prescribed message format including the Fedwire prescribed field description, the Fedwire field tag and a description of the data included in the field. In accordance with at least one embodiment of the invention, various fields included in the Fedwire message format (corresponding to field tags 1510, 3100, 3400, 3600, 4000 and 6100, highlighted in Table 1) include data that remains constant for a particular Receiver Financial Institution processing financial transactions from a particular Client Bank. Therefore, a particular Receiver Financial Institution utilizing the invention, need only keep the data in these fields constant when generating SWIFT compatible format message (described below with reference to Table 2) for all processed international financial transactions. It should be understood that not all fields provided in the Client Bank's Fedwire message transmitted to the Receiver Financial Institution are included in the generated SWIFT compatible format message because not all of the Fedwire message fields are necessary to provide complete and accurate instructions to a foreign Processing Financial Institution for processing a financial transaction benefiting a foreign beneficiary.

The data included in the sender reference field (field tag 3320) may include data indicating a reference identification code assigned to the particular financial transaction being processed by the Receiver Financial Institution. The data included in the Receiver ABA/Name field (field tag 3400) may include data indicating the Receiver Financial Institution that is handling the financial transaction, i.e., the financial institution that is maintaining and operating the mechanism and process of the invention. The data included in the beneficiary's financial institution field (field tag 4100) may include data indicating the beneficiary's financial institution including its identifier code (e.g., its SWIFT BIC), as well as other identifier information including its name and address. The data included in the beneficiary field (field tag 4200) may include a reference identification code for the beneficiary's demand deposit account to be credited at the beneficiary's financial institution, as well as other identifier information including the beneficiary's name and address. The data included in the originator field (field tag 5000) may include a reference identification code for the individual originator's demand deposit account to be drawn upon at the Client Bank, as well as other identifier information including the individual originator's name and address.

The data included in the originator's financial institution field (field tag 5100) and the instructing financial institution field (field tag 5200) may include a reference identification code for the a demand deposit account associated with the Client Bank to be drawn upon when processing the financial transaction, as well as other identifier information including the Client banks name and address.

The data included in the originator to beneficiary message field (field tag 6000) may include data indicating for example, the nature of the transaction, what it pertains to or special instructions associated with the transaction. The data included in the receiver information field (field tag 6100) may include data indicating how the institutions processing the transaction handle funding of the transaction, e.g., bene-deduct (explained herein), full payment, etc. The data included in the information for beneficiary's bank field (field tag 6300) may include data indicating specific instructions for payment to be handled by the foreign beneficiary bank. The data included in the beneficiary bank advice information field (field tag 6310) may include data indicating specific instructions for notification from the foreign beneficiary bank to the beneficiary or from the foreign beneficiary bank back to the a correspondent bank. Similarly, data included in the beneficiary advice field (field tag 6410) may include specific instructions for notifying the beneficiary of the financial transaction regarding the processing of the transaction.

Returning to the description of FIG. 4, control proceeds to 410, at which a determination is made whether special payment account information is encoded within the received Fedwire transfer message. Specifically, information must be encoded with the transfer message that indicates a special account of the Client Bank at the Receiver Financial Institution, that special account being designated only for use in processing foreign payments.

Transfers encoded with information indicating a required special account are further examined for acceptability of related fields including the originator information, beneficiary information, Client Bank, and Paying Bank. If not, control proceeds to 415, at which the Fedwire transfer is processed through an other interbank financial transaction system and control proceeds to completion of the process at 510.

If so, control proceeds to 420, at which a determination is made whether the instructed financial transaction is approved by the Receiver Financial Institution's OFAC. Financial institutions, by U.S. law, cannot honor certain transactions. OFAC processing makes a record of the instructions submitted and embargoes associated funds until a resolution is determined. If the instructed financial transaction is not compliant with OFAC directives, control proceeds to 425, at which the financial transaction instruction is remitted to the OFAC and the OFAC holds the funds associated with the instructed financial transaction and control proceeds to completion of the process at 510.

If the instructing financial transaction is compliant with OFAC directives, control proceeds to 430, at which it is determined whether required data fields pass editing requirements. At 435, any instructing financial transaction that do not pass the examination edits are designated as rejected and returned to the Client Bank via the Fedwire system and control proceeds to completion of the process at 510. Alternatively, control proceeds to 440, at which a determination that the required data fields are acceptable results in a credit to the Client Bank's special account for foreign payments. Subsequently, at 445, a funds transfer instruction is generated and transmitted from the Receiver Financial Institution to the Processing Financial Institution to the benefit of the payee, i.e., the beneficiary of the financial transaction.

Thus, the Receiver Financial Institution, upon successful acceptance of a payment authorization and delivery instruction for an international payment, generates a message in a SWIFT compatible format and transmits that message to the Processing Financial Institution. An example of this SWIFT compatible message format is illustrated in Table 2. The format illustrated in Table 2 is in conformance with SWIFT's MT103 format for single customer credit transfers, which include specified fields of data for use in cross-border financial transactions.

As may be understood in connection with Tables 1 and 2, content of the Fedwire format message (an example of which being illustrated in Table 1) received by the Receiver Financial Institution may be mapped into corresponding fields included in the SWIFT compatible format message (an example of which being illustrated in Table 2). For example, the content included in Fedwire field tag 3320 (sender reference) may be mapped to the sender's reference field in the SWIFT compatible format message. Similarly, the content included in Fedwire field tag 4000 (intermediary financial institution) may be mapped to the sender's correspondent field in the SWIFT compatible format message. Likewise, the content included in Fedwire field tags 4100 (beneficiary's financial institution), 4200 (beneficiary) and 5000 (originator) may be mapped to the account with institution field, beneficiary customer field and ordering customer field, respectively, in the SWIFT compatible format message. It should be understood that other mappings are possible and may be implemented to provide the functionality of the invention; thus, the above-described mapping is merely one potential implementation. Remaining fields included in the SWIFT compatible message may be populated based on information known to the Receiver Financial Institution and/or based on other information included in the Fedwire message format.

Once the SWIFT compatible message has been generated, the Receiver Financial Institution distributes the message internally at 450. Control then proceeds to 455, at which a determination is made whether the payee/beneficiary for the transaction is an account holder at a branch of the Receiver Financial Institution. If so, control proceeds to 460 at which, funding for the payment is made by initiating a book-to-book transfer into accounts of the branch who will, in turn, credit monies into the account of the beneficiary to complete the transaction.

If, at 455, it is determined that the payee is not an account holder at a branch of the Receiver Financial Institution, control proceeds to 465, at which a determination is made whether the Paying Bank is a member of CHIPS or Fedwire. If so, control proceeds to 470, at which, the Paying Bank receives fully funded instructions from the Receiver Financial Institution and a book to book transfer is initiated. If the Paying Bank is not a participant in Fedwire or CHIPS, control proceeds to 475, at which the Receiver Financial Institution selects a correspondent bank based on the country of the Paying Bank.

Subsequently, control proceeds to 480, at which a determination is made whether the payee/beneficiary has an account at the Processing Bank. If so, control proceeds to 485, at which the Receiver Financial Institution initiates a book to book transfer into an account of the Processing Bank at the Receiver Financial Institution and the Processing Bank, in turn, credits monies into the account of the beneficiary to complete the transaction. If, at 480, it is determined that the payee/beneficiary does not have an account at the Processing Bank, control proceeds to 490 at which a determination is made whether the Paying Bank has an account at the Processing Bank. If so, control proceeds to 495, at which, the Receiver Financial Institution generates a SWIFT compatible message, e.g., a message compatible with the SWIFT MT 103 format including instructions for the transaction and transmits the message to the intermediary financial institutions and Paying Bank completing the payment.

If, at 490, it is determined that the Paying Bank has no account at the Processing Bank, control proceeds to 500, at which the Receiver Financial Institution instructs the selected Processing Bank to credit in favor of the payee/beneficiary at the Paying Bank through, e.g., an interbank funds transfer consortium. Funding uses monies from a book transfer at the Receiver Financial Institution for the Processing Bank and a credit to the interbank settlement account of the intermediary.

Subsequent to the actions performed at 460, 475, 480, 490 and 500, control proceeds to 505, at which the paying bank notifies the payee/beneficiary of a credit, thus, confirming that the financial transaction has been finalized. Control then proceeds to completion of the process at 510.

It should be understood that, in the case of payments on the accounts of financial institutions that are Processing Banks of the Receiver Financial Institution, the generated SWIFT compatible message is processed against their accounts at the Receiver Financial institution, allowing the Processing Banks to credit the international payee account finalizing the transaction. When a payee/beneficiary is an accountholder with a financial institution that is a downstream correspondent bank or intermediary bank by way of the Receiver Financial Institution's Processing Bank, then the instructions included in the SWIFT compatible message must be processed for that downstream correspondent or intermediary bank. Such additional processing actions are not illustrated in FIG. 4 but would be readily understood by one of ordinary skill in the art. The correspondent bank, as the Processing Bank, can then fund the financial transaction through a book-to-book movement of monies at the Receiver Financial Institution. The Paying Bank can then credit the account of the payee at their institution.

In certain cases, neither the Receiver Financial Institution's branch nor their Processing Banks have a relationship with the payee. Thus, transaction instructions would include the name of a Paying Bank that is a member of CHIPS, Fedwire or some other funds transfer consortium where settlement can be accomplished. This is known as an intermediary financial institution as well as the Paying Bank.

It should also be understood that the final payout to the beneficiary may be in the form of a credit to the payee/beneficiary account. Alternatively, a foreign draft may be issued.

In accordance with at least one embodiment of the invention, the mechanism and process provide financial transactions that are “self-funding.” That is, financial institutions that are part of the chain of institutions processing the financial transaction to enable settlement thereof, are assured that there is sufficient funding available for the transaction. This self-funding feature is based, at least in part, on using the Fedwire system (conventionally used for funding domestic credit transfer transactions) for processing international payout transactions. By requiring that a Client Bank be a member of the Fedwire system, the Receiver Financial Institution is ensured that the funds necessary to implement the financial transaction are available. This is because the Fedwire system requires that members settle transactions initiated using the system at a certain time daily; this, in turn, requires that the bank requesting a financial transaction have the necessary funds associated with that transaction in the Fedwire system at the time of settlement (i.e., on that day). Deficiencies are prevented by the U.S. Federal Reserve Bank and their insurance procedures.

Likewise, within the chain of processing associated with the financial transaction, various relationships are utilized to ensure that the Processing Banks have full faith of immediate payment because the transaction is self-funding. Such relationships may include the relationship between the Receiver Financial Institution and its branch or a correspondent bank, the relationship between such a correspondent bank and its correspondent banks and/or branches and/or other financial institutions that participate in any number of funds transfer consortiums, e.g., the Swiss Interbank Clearing funds transfer system.

Various payment configurations may be used to convey service transaction fees to the financial institutions involved in making the financial transaction. For example, it is an accepted practice in international markets for the beneficiary of a financial transaction to pay the transaction fees associated with international wires, a practice known as bene-deduct. Thus, in accordance with at least one embodiment of the invention, fee payments are provided to the financial transactions included in the financial transaction processing chain using the bene-deduct option. Alternatively, processing fees could be withdrawn from a separate account set up specifically for that purpose; such an account could be maintained at the Processing Bank by the Foreign Beneficiary Bank to process the financial transaction.

In accordance with at least one embodiment of the invention, the mechanism and process may provide or include the capability of providing payment confirmation and advice information via a browser-based cash management system and/or transaction inquiry systems associated with and maintained by the Receiver Financial Institution. Such transaction inquiry systems may, for example, provide online access to historical payment data to include copies of a Client Bank's original Fedwire instruction and the Receiver Financial Institution's outgoing SWIFT message to the foreign beneficiary bank. Client Bank's access may also be enabled for checking account balances, debit/credit summaries, or detailed reports indicating the offsetting payment method, Receiver Financial Institution transaction reference numbers and associated reference numbers.

In accordance with at least one embodiment of the invention, real-time, current day information regarding balances and transaction activity is available for a Client Bank to access from the Receiver Financial Institution using SWIFT or a personal computer interface. Thus, a Client Bank can confirm execution of outgoing wires as well as become aware of unanticipated incoming transactions.

It should be understood that, although the invention embodiments have been described with specific reference to remitting instructing financial transactions and associated funds to the OFAC based on specific conditions, the invention may be implemented with alternative or additional remissions and submissions to other regulatory compliance entities or agencies depending on relevant regulatory requirements.

Furthermore, it should be understood that the invention may be implemented using some mechanism other than the Fedwire system, provided that such a mechanism ensures guaranteed transaction funding to the Receiver Financial Institution. Additionally, a message format other than MT103, and other than that provided by SWIFT may be used to transmit financial transaction instructions from the Receiver Financial Institution provided that such a message format is compatible with, i.e., understandable and usable by, both the Receiver Financial Institution and the selected Processing Institution and provided that the format includes sufficient information for the Processing Institution to provide instructions to a Paying Bank.

It should be appreciated that the above-described embodiments are merely illustrative of the inventive concept and that various modifications and adaptations may be made to those embodiments without departing from the invention.

TABLE 1

| FIELD DESCRIPTION | FIELD TAG | DATA |
|---|---|---|
| TYPE CODE | 1510 | 1000 |
| AMOUNT | 2000 | (AMOUNT OF THE TRANSACTION) |
| SENDER ABA/NAME | 3100 | (YOUR ABA) |
| | | (YOUR TELEGRAPHIC SHORTNAME) |
| SENDER REFERENCE | 3320 | (YOUR REFERENCE) |
| RECEIVER ABA/NAME | 3400 | 021000018 |
| | | BK OF NYC |
| BUSINESS FUNCTION CODE | 3600 | CTR |
| INTERMEDIARY FINANCIAL INSTITUTION | 4000 | (See Below) |
| Id code | | D |
| Id Identifier | | 8900000000 |
| Id Name | | (Your Bank's Name) |
| Id address | | (Your Address) |
| Id address | | (Your Address) |
| Id address | | (Your Address) |
| BENEFICIARY'S FINANCIAL INSTITUTION | 4100 | (See Below) |
| Id code | | (E.G.: B) |
| Id Identifier | | (E.G.: CTBAAU2S) |
| Id Name | | (Bene Bank's Name:IE Commonwealth BK of Australia) |
| Id address | | (Bene Bank's Address: E.G.: Sydney) |
| Id address | | (Bene Bank's Address) |
| Id address | | (Bene Bank's Address) |
| BENEFICIARY | 4200 | (See Below) |
| Id code | | (D) |
| Id Identifier | | 1234567890 |
| Id Name | | (Beneficiary's name.) |
| Id address | | (Beneficiary's address.) |
| Id address | | (Beneficiary's address.) |
| Id address | | (Beneficiary's address.) |
| ORIGINATOR | 5000 | (See Below) |
| Id code | | D |
| Id Identifier | | 1234567890 |
| Id Name | | (Ordering party's name) |
| Id address | | (Ordering party's address) |
| Id address | | (Ordering party's address) |
| Id address | | (Ordering party's address) |
| ORIGINATOR'S FINANCIAL INSTITUTION | 5100 | (See Below) |
| Id code | | D |
| Id Identifier | | 1234567890 |
| Id Name | | (Ordering Customer's Financial Institution's name) |
| Id address | | (Ordering Customer's Financial Institution's address) |
| Id address | | (Ordering Customer's Financial Institution's address) |
| Id address | | (Ordering Customer's Financial Institution's address) |
| INSTRUCTING FINANCIAL INSTITUTION | 5200 | (See Below) |
| Id code | | D |
| Id Identifier | | 1234567890 |
| Id Name | | (Instructing Institution's name) |
| Id address | | (Instructing Institution's address) |
| Id address | | (Instructing Institution's address) |
| Id address | | (Instructing Institution's address) |
| ORIGINATOR TO BNF INFORMATION | 6000 | (E.G.: “FOR 1000 TONS OF WHEAT” |
| RECEIVER INFORMATION | 6100 | OUR, BEN, or /FULLPAY/ |
| INFO FOR BENEFICIARY'S BANK | 6300 | (E.G.: PAY THRU YOUR GATEWAY BRANCH |
| BENE BANK ADVICE INFORMATION | 6310 | (E.G.: PHN) |
| BENEFICIARY ADVICE | 6410 | (E.G.: TLX) |

TABLE 2

| TAG | FIELD NAME |
|---|---|
| 20 | SENDER'S REFERENCE |
| 13C | TIME INDICATION |
| 23B | BANK OPERATION CODE |
| 23E | INSTRUCTION CODE |
| 26T | TRANSACTION TYPE |
| | CODE |
| 32A | VALUE DATE/ |
| | CURRENCY/INTERBANK |
| | SETTLED AMOUNT |
| 33B | CURRENCY/INSTRUCTED |
| | AMOUNT |
| 36 | EXCHANGE RATE |
| 50a | ORDERING CUSTOMER |
| 51A | SENDING INSTITUTION |
| 52a | ORDERING INSTITUTION |
| 53a | SENDER'S |
| | CORRESPONDENT |
| 54a | RECEIVER'S |
| | CORRESPONDENT |
| 55a | THIRD REIMBURSEMENT |
| | INSTITUTION |
| 56a | INTERMEDIARY |
| | INSTITUTION |
| 57a | ACCOUNT WITH |
| | INSTITUTION |
| 59a | BENEFICIARY |
| | CUSTOMER |
| 70 | REMITTANCE |
| | INFORMATION |
| 71A | DETAILS OF CHARGES |
| 71F | SENDER'S CHARGES |
| 71G | RECEIVER'S CHARGES |
| 72 | SENDER TO RECEIVER |
| | INFORMATION |
| 77B | REGULATORY |
| | REPORTING |
| 77T | ENVELOPE CONTENTS |

1. A method for processing a payment to a financial transaction beneficiary in a foreign country, the method comprising:
receiving financial transaction payment instructions from a Client Bank in a format associated with a mechanism that provides guaranteed funding of the transaction to a Receiver Financial Institution;
analyzing the received financial transaction payment instructions; and
generating foreign financial transaction payment instructions for at least one financial institution in a foreign country, the foreign financial transaction payment instructions including data in a format that is compatible with both the Receiver Financial Institution and the at least one financial institution in a foreign country.

2. The method of claim 1, wherein the mechanism that provides guaranteed funding of the transaction to a Receiver Financial Institution is the Fedwire system.

3. The method of claim 2, wherein the format that is compatible with both the Receiver Financial Institution and the at least one financial institution is SWIFT compatible.

4. The method of claim 2, wherein the foreign financial transaction payment instructions comply with specifications of SWIFT MT 103.

5. The method of claim 1, wherein the Client Bank is a domestic bank.

6. The method of claim 1, wherein the financial transaction is self-funding.

7. The method of claim 1, wherein the instructions are received via an interface from the Fedwire system.

8. The method of claim 1, further comprising transmitting the foreign financial transaction payment instructions to the at least one financial institution in the foreign country.

9. The method of claim 8, wherein the at least one financial institution in the foreign country includes a branch of the Receiver Financial Institution that generated and transmitted the foreign financial transaction payment instructions.

10. The method of claim 8, wherein the at least one financial institution in the foreign country includes a member of the ClearingHouse Interbank Payment System.

11. The method of claim 8, wherein the at least one financial institution in the foreign country includes a member of the Fedwire funds transfer system.

12. The method of claim 8, wherein the at least one financial institution in the foreign country includes a SWIFT-connected correspondent bank to the Receiver Financial Institution that generated and transmitted the foreign financial transaction payment instructions, the correspondent bank handling business in a particular geographic area.

13. A mechanism for processing a payment to a financial transaction beneficiary in a foreign country, the mechanism comprising:
an interface for receiving payment instructions from a Client Bank in a format associated with a mechanism that provides guaranteed funding of the transaction to a Receiver Financial Institution; and
at least one processor including software for analyzing the received financial transaction payment instructions and generating foreign financial transaction payment instructions for at least one financial institution in a foreign country, the foreign financial transaction payment instructions including data in a format that is compatible with both the Receiver Financial Institution and the at least one financial institution in a foreign country.

14. The mechanism of claim 13, wherein the mechanism that provides guaranteed funding of the transaction to a Receiver Financial Institution is the Fedwire system.

15. The mechanism of claim 14, wherein the format that is compatible with both the Receiver Financial Institution and the at least one financial institution is SWIFT compatible.

16. The mechanism of claim 14, wherein the foreign financial transaction payment instructions comply with specifications of SWIFT MT 103.

17. The mechanism of claim 13, wherein the Client Bank is a domestic bank.

18. The mechanism of claim 13, wherein the financial transaction is self-funding.

19. The mechanism of claim 13, wherein the interface is an interface with the Fedwire-system.

20. The mechanism of claim 13, wherein the at least one processor initiates transmission of the foreign financial transaction payment instructions to the at least one financial institution in the foreign country.

21. The mechanism of claim 20, wherein the at least one financial institution in the foreign country includes a branch of the Receiver Financial Institution that generated and transmitted the foreign financial transaction payment instructions.

22. The mechanism of claim 20, wherein the at least one financial institution in the foreign country includes a member of the ClearingHouse Interbank Payment System.

23. The mechanism of claim 20, wherein the at least one financial institution in the foreign country includes a member of the Fedwire funds transfer system.

24. The mechanism of claim 20, wherein the at least one financial institution in the foreign country includes a SWIFT-connected correspondent bank to the Receiver Financial Institution that generated and transmitted the foreign financial transaction payment instructions, the correspondent bank handling business in a particular geographic area.
